(19) United States
(12) Patent Application Publication
(10) Pub. No.: US 2003/0203077 A1
(43) Pub. Date: Oct. 30, 2003

(54) Waffle ice cream sandwich & method

(76) Inventor: Bart Charles, San Capistrano, CA (US)

Correspondence Address: ANDERSON KILL & OLICK, P.C., 1251 Avenue of the Americas, New York, NY, 10020, US

(21) Appl. No.: 10/423,759

(22) Filed: Apr. 25, 2003

Related U.S. Application Data
(60) Provisional application No. 60/375,693, filed on Apr. 26, 2002.

(51) Int. Cl. A23G 1/00

(52) U.S. Cl. 426/100

(57) ABSTRACT

A toasted waffle ice cream sandwich comprising an outer body composed of a toasted waffle composition surrounding and enclosing a body of solid ice cream formed by the method comprising the steps of placing ice cream between two preformed waffles in a waffle toaster and flash heating the waffles at a predetermined relatively high temperature over a short time interval such that the waffles surround the ice cream with the exterior thereof fully toasted while the interior thereof adjacent the ice cream remains at a temperature sufficiently cold to retain the ice cream in solid form.

This is a continuation-in-part of U.S. patent application Ser. No. 60/375,693 filed Apr. 26, 2002 and relates to a waffle ice cream confection product and method for making the product. More particularly, the present invention relates to an ice cream sandwich composed of a toasted waffle covering fully enclosing a body of solid ice cream at a temperature sufficiently cold to retain the ice cream in solid form and to a method of forming a waffle ice cream sandwich having an outer covering composed of a preformed waffle surrounding a body of ice cream flash heated to toast and preferably seal the waffle exterior without melting the ice cream creating a no drip sealed waffle sandwich.

### FIELD OF THE INVENTION

### BACKGROUND

Conventional sandwiches of ice cream are formed by placing ice cream between layers of a dairy or non-dairy food composition in precooked form such as a cookie, cracker etc. and is generally packaged as a frozen product. It is also conventional to place ice cream over a heated waffle to create what is commonly referred to as a “Belgium waffle”. It is, however, difficult to form a sandwich of waffle and ice cream since a waffle is formed from a batter mix of flour, milk, eggs etc. having a loose consistency which must first be toasted in a waffle toaster before the ice cream can be placed between the two layers of toasted waffle. Moreover, if the toasted waffle layers or slices are hot the ice cream will melt too quickly when placed between the waffle layers for sale as an ice cream sandwich.

### SUMMARY

It has been discovered in accordance with the present invention that a sandwich composed of two layers of waffle with ice cream between the layers can be formed simultaneously while toasting the waffle in a toaster without melting the ice cream. This is accomplished in accordance with the present invention by placing the ice cream between two preformed soft sponge-like solified bodies, each of which is formed from conventional waffle batter mix which may be partially precooked or prebaked. Each of the preformed waffle bodies shall hereafter be referred to as a “preformed waffle”. A preformed waffle suitable for use in the present invention is commercially available by Kellogg under the trademark EGG-O. The arrangement of two preformed waffles and ice cream is then flash toasted between two dies in a conventional waffle or sandwich toaster under controlled conditions of temperature and time thereby forming a waffle ice cream sandwich containing ice cream in solid form. Although any conventional waffle toaster can be used it is preferred to use a sandwich toaster as is commercially available from Wisco Industries which includes an annular lip around each reservoir in each of the toaster dies to form a perimeter seal around the sandwich during toasting.

The method of the present invention involves flash heating the preformed waffle ice cream sandwich at a relatively high temperature over a very short time interval to cause the exterior of the preformed waffle to become fully toasted while the interior thereof is cooked with the temperature adjacent the ice cream being sufficiently cold such that the ice cream remains solid. Additional ingredients may also be included with the ice cream before it is flash heated.

The ice cream sandwich of the present invention comprises an outer covering composed of a toasted waffle enclosing a body of solid ice cream. The method of forming a waffle ice cream sandwich in accordance with the present invention comprises the steps of placing ice cream between two preformed waffles, inserting the arrangement of preformed waffles and ice cream between opposing dies in a waffle or sandwich toaster and flash heating the waffles at a predetermined relatively high temperature of between 380° F. and 425° F. over a short time interval of up to 15 seconds maximum, preferably between 8-12 seconds, such that the exterior of the preformed waffles are fully toasted while the interior thereof remains at a temperature sufficiently cold to retain the ice cream in solid form.

Other objects and advantages of the present invention will become apparent when read in conjunction with the drawings and detailed description of the invention as follows:

### BRIEF DESCRIPTION OF THE DRAWINGS

FIG. 1A is a top plan view of a circular preformed waffle used to make a toasted ice cream sandwich in accordance with the invention;

FIG. 1B is a top plan view of a molded ice cream puck used in accordance with a preferred embodiment of the invention.

FIG. 1C is a top plan view of a molded ice cream puck in the form of a dome used in accordance with the invention;

FIG. 2 is a side view showing the arrangement of the ice cream between preformed waffles prior to toasting;

FIG. 3 is a side view of the finished product, i.e., after toasting;

FIG. 4 is a side sectional view of an embodiment of the invention in which two dome shaped molded ice pucks are used;

FIG. 5 is a side view of another embodiment of the invention in which a single molded ice cream puck is used;

FIG. 6 is an exploded cross sectional diagrammatic representation of opposing dies of a conventional sandwich toaster shown in combination with the ice cream sandwich arrangement corresponding to FIG. 2 or FIG. 5 in its relative position between the dies before toasting for making the waffle ice cream sandwich of the present invention; and

FIG. 7 shows the two dies of FIG. 6 in the die closed position for forming the finished product of FIGS. 3 or 4 after toasting.

### DETAILED DESCRIPTION

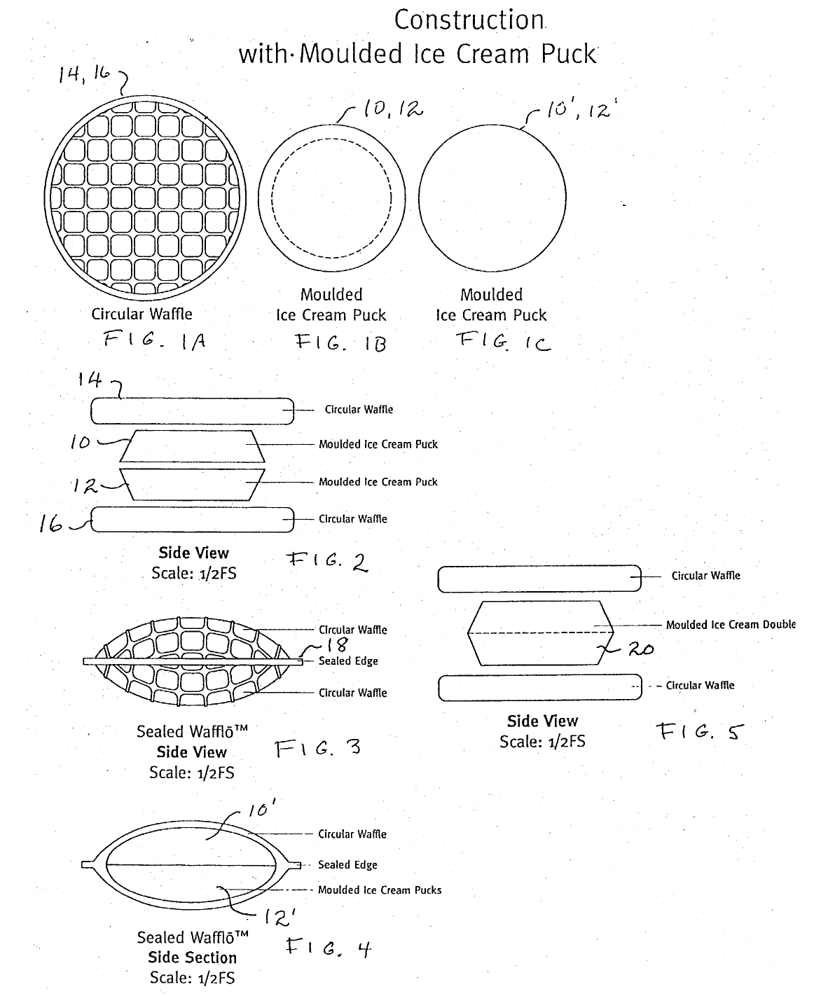

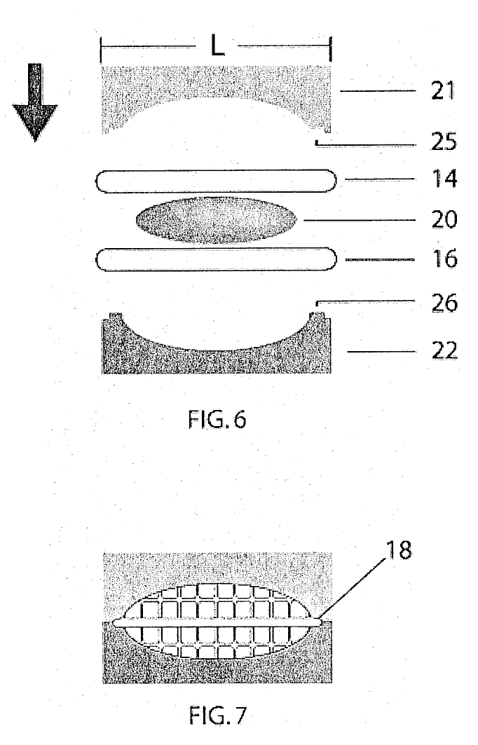

The first embodiment of the invention is illustrated in FIGS. 1A, 1B, 2 and 3 in conjunction with FIGS. 5 and 6. The product is an ice cream sandwich comprising two molded ice cream pucks 10 and 12, each designating a solid body of ice cream of any desired geometry, which may or may not have a dairy or non-dairy edible shell like outer covering, e.g. a thin coating of chocolate, and a pair of preformed waffles 14 and 16 composed from a conventional waffle batter mix of flour, milk, eggs, etc. The preformed waffles 14 and 16 are each in the configuration of a disk of circular geometry although they can be preformed into any desired configuration and/or geometry and may have a preformed cross hatched patterened surface 17 as shown in FIG. 1A typical of a waffle. The preparation of the preformed waffles 14 and 16 into solidified bodies of any desired geometry and the exact ingredient mix thereof do not form a part of the present invention.

A waffle ice cream sandwich product is made by arranging the ice cream pucks 10 and 12 one on top of the other, as shown in FIG. 2, placing them between the preformed waffles 14 and 16, inserting the waffle sandwich arrangement into a conventional waffle toaster or sandwich toaster and flash toasting the waffles thereby forming a waffle ice cream sandwich having an outer covering composed of a toasted waffle enclosing a body of solid ice cream located there between. The ice cream will remain in solid form even after the waffle ice cream sandwich is removed from the toaster for at least another ten to twenty minutes at room temperature.

A conventional sandwich toaster as is commercially available from Wisco Industries is preferred for use in toasting the waffle ice cream sandwich arrangement of FIGS. 2 or 5. A diagrammatic representation of the opposing dies of the preferred Wisco sandwich toaster model is shown in FIGS. 6 and 7 in combination with the ice cream arrangement of FIG. 2 or FIG. 5. The sandwich toaster comprises a pair of opposing steel dies 20 and 22 each containing a cavity 23 and 24 of complementary eliptical geometry. A recessed annular lip 25 and 26 surrounds the edge of each of the die cavities 23 and 24. The die cavities 23 and 24 are sized to accommodate the preformed waffles 14 and 16 and function as recepticles for the preformed waffles during toasting. It is however necessary for the diameter or cross-sectional length of the preformed waffles 14 and 16 to be sized approximately equal to or greater than the length “L” of the dies 20 and 22 so that when the dies 20 and 22 engage one another the preformed waffles 14 and 16 will be clamped together at their respective edges during toasting. Moreover, if the diameter of the preformed waffles 14 and 16 are sized such that their diameter or cross-sectional length is larger than the length L of the dies than the annular lip 25 and 26 will function to cut off excess material extending beyond the diameter L. Clamping the preformed waffles 14 and 16 together at their respective edges during toasting results in forming a sealed perimeter 18 at the approximate mid-point of the toasted waffle sandwich as shown in FIG. 3. The flash toasting operation forms a single toasted waffle body 28 which will fully enclose the body of solid ice cream. A perimeter seal 18 is very desirable and beneficial to keep the ice cream enclosed so that it is less likely to drip even after it begins to melts.

The sandwich toaster is operated by bringing the opposing steel dies 20 and 22 into engagement with the toaster turned on through a control (not shown) for electrically connecting the opposing dies 20 and 22 in common to a source of electrical energy. The toasting temperature is a variable as is the operating time.

It has been discovered in accordance with the present invention that by flash toasting the waffle sandwich formed from two preformed waffles 14 and 16 with one or two ice cream pucks 10 and 12 there between in a waffle toaster or sandwich toaster at high temperature in a short time interval will simultaneously form a toasted waffle enclosing a solid body of ice cream. The the waffle sandwich arrangement must be flash heated at a predetermined relatively high temperature of between 380° F. and 425° F. and over a short time interval of up to 15 seconds maximum, preferably between 8-12 seconds such that the exterior of the preformed waffles will be fully toasted while the interior thereof is cooked but nevertheless is permitted to remain sufficiently cold at the surface adjacent to the ice cream to retain the composition of the ice cream in a solid form. In this regard the toasted waffle body tends to act as an insulator for the ice cream so that the ice remains solid within the enclosed toasted waffle body even after removal from the toaster and for a time period of at least 10-20 minutes at ambient temperature. This allows for enough time for the waffle ice cream sandwich to be eaten at room temperature without the ice cream melting.

The shape of the finished toasted waffle product is shown in FIG. 3 and FIG. 6 respectively and its configuration is dependent upon the configuration of the preformed waffles 14 and 16. The die cavities 23 and 24 should have a geometry compatible with the selected configuration of the preformed waffles.

In the preferred embodiment, the ice cream pucks 10 and 12 have beveled side edges. This shape facilitates the forming and sealing of the top and bottom waffles 14 and 16 to one another during toasting even using a conventional waffle toaster. Alternatively, the pucks 10 and 12 may be dome-shaped as shown in FIGS. 1C, 4 and 6. A single molded puck 20 also can be used as shown, for example, in FIG. 5. Other shapes are also possible.

Additional ingredients such as fruit fillings or flavored syrups can be added to the ice cream before toasting. In such case the puck(s) can be molded with a recess or compartment to retain the ingredients. When two separate ice cream pucks 10 and 12 are employed, each may be made of a different flavor, for example, chocolate and vanilla.

The ice cream sandwich as described above may be delivered to consumers in a specially made plastic or cardboard tray which will have an area capable of holding a single ice cream sandwich together with a series of pockets for holding special “dipping” sauces.

What is claimed is:

1. A toasted waffle ice cream sandwich comprising an outer body composed of a unitary toasted waffle composition surrounding and enclosing a body of solid ice cream which will remain solid over a relatively long time period at ambient temperature.

2. A toasted waffle ice cream sandwich as defined in claim 1 in which the toasted waffle encloses other ingredients, in addition to the ice cream, selected from the group consisting of fruit fillings and/or flavored syrups.

3. A method of forming a waffle ice cream sandwich comprising the steps of placing ice cream between two preformed waffles in a waffle toaster and flash heating the arrangement of ice cream and preformed waffles at a predetermined relatively high temperature of between 380° F. and 425° F. over a short time interval of up to a maximum of 15 seconds such that the exterior of the preformed waffles become fully toasted while the interior thereof adjacent the ice cream remains at a temperature sufficiently cold to retain the ice cream in solid form over a relatively long time period even after withdrawal from the toaster.

4. A method as defined in claim 3 wherein the waffle toaster into which the preformed waffles are placed includes opposing dies with the preformed waffles having a diameter or cross-sectional length at least equal to the longitudinal cross-sectional length of the dies.

5. A method as defined in claim 4 wherein the time period is between five to minutes.

6. A method as defined in claim 5 wherein the flash heating time interval is between 8-12 seconds.

7. A method as defined in claim 6 wherein the peformed waffles are toasted in the waffle toaster to fully enclose the ice cream.

8. A toasted waffle ice cream sandwich comprising an outer body composed of a toasted waffle composition surrounding and enclosing a body of solid ice cream formed by the method comprising the steps of placing ice cream between two preformed waffles in a waffle toaster and flash heating the waffles at a predetermined relatively high temperature over a short time interval such that the waffles surround and enclose the ice cream with the exterior thereof fully toasted while the interior thereof adjacent the ice cream remains at a temperature sufficiently cold to retain the ice cream in solid form.
